(19) United States
(12) Patent Application Publication
(10) Pub. No.: US 2023/0319056 A1
(43) Pub. Date: Oct. 5, 2023

(54) LIMITING ACCESS OF A USER DEVICE TO A WEBSITE

(71) Applicant: Lenovo (United States) Inc., Morrisville, NC (US)

(72) Inventor: Allen Richey, Frisco, TX (US)

(21) Appl. No.: 17/708,225

(22) Filed: Mar. 30, 2022

(51) Int. Cl. H04L 9/40

(52) U.S. Cl. CPC H04L 63/108; H04L 63/101

(57) ABSTRACT

One embodiment provides a method, the method including: receiving, at a device access limiting system, an indication of a plurality of user devices to be in operative communication with a central device during a predetermined time period; receiving, at the device access limiting system from the central device, an indication for a request to be transmitted to the plurality of user devices to access a website during the predetermined time period; determining, using the device access limiting system, the indication includes an indication to limit access of the plurality of user devices to the website; and limiting, using the device access limiting system, access of the plurality of user devices to the website.

### BACKGROUND

With the increase in virtualization, more meetings are being conducted using remote communication connections and software that facilitates the meetings. One area that has seen a surge in virtualization is school or other classroom settings. Rather than all students and a teacher being physically located in the same space, the teacher can be located in one physical location and one or more of the students can be located in different physical locations. Classroom management software is employed to allow the teacher to transmit information to the student devices simultaneously. Additionally, the teacher's console, or central system, provides some control over the devices of the student(s), or user devices. For example, the central device can dictate websites or applications that can be accessed by the user devices during the classroom time, or predetermined time period.

### BRIEF SUMMARY

In summary, one aspect provides a method, the method including: receiving, at a device access limiting system, an indication of a plurality of user devices to be in operative communication with a central device during a predetermined time period; receiving, at the device access limiting system from the central device, an indication for a request to be transmitted to the plurality of user devices to access a website during the predetermined time period; determining, using the device access limiting system, the indication includes an indication to limit access of the plurality of user devices to the website; and limiting, using the device access limiting system, access of the plurality of user devices to the website.

Another aspect provides an information handling device, the information handling device including: a central device; a plurality of user devices; a processor operatively coupled to the central device and the plurality of user devices; a memory device that stores instructions that, when executed by the processor, causes the information handling device to: receive, at a device access limiting system, an indication of the plurality of user devices to be in operative communication with the central device during a predetermined time period; receive, at the device access limiting system from the central device, an indication for a request to be transmitted to the plurality of user devices to access a website during the predetermined time period; determine, using the device access limiting system, the indication includes an indication to limit access of the plurality of user devices to the website; and limit, using the device access limiting system, access of the plurality of user devices to the website.

A further aspect provides a product, the product including: a computer-readable storage device that stores executable code that, when executed by a processor, causes the product to: receive, at a device access limiting system, an indication of a plurality of user devices to be in operative communication with a central device during a predetermined time period; receive, at the device access limiting system from the central device, an indication for a request to be transmitted to the plurality of user devices to access a web site during the predetermined time period; determine, using the device access limiting system, the indication includes an indication to limit access of the plurality of user devices to the website; and limit, using the device access limiting system, access of the plurality of user devices to the website.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for limiting access of user devices to a web site that is included in a request transmitted by a central device and that includes an indication to limit access of the devices to the website.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When dictating the websites or applications that can be accessed by the user devices, the central device can not only dictate which websites or applications that can be accessed by the user devices, but can also dictate when the website or application becomes accessible. In other words, as the teacher is teaching or moving through the class agenda, the teacher can identify and push websites to the user devices, thereby allowing the user device to access the website at that time. This is referred to as a push website in conventional classroom management software.

Conventional classroom management software does not provide any additional features with the push website request. Specifically, while the teacher can identify the web site to be accessed by the students, the teacher cannot limit access of the device to only that website. Additionally, the teacher cannot identify how long the device should be limited to accessing only that website. Instead, conventional systems provide the web site to the user devices and rely on the student to access the website and only the website, as instructed. In other words, the classroom management software does not provide a feature like in a traditional classroom where the teacher physically monitors the students to make sure the student is performing the expected and requested action.

The only way that the user can limit access of the device to only the website is a multiple step process that requires accessing multiple windows. First, the teacher has to push the website to the students, which occurs in one window of the software. The teacher then must access another window to configure the only allow web limiting option which limits access of the devices to only websites. However, this still does not fully limit the user devices to just the single website. Instead, the teacher must access another window, specifically, the website allow list, to limit the accessible websites to the single desired website. Not only does this take time, which allows the students time to access other websites or applications on the device, but it is also cumbersome. Additionally, when the teacher wants to revert back to the original settings or new settings, the teacher has to perform all of these steps again.

Accordingly, the described system and method provides a technique for limiting access of user devices to a website that is included in a request transmitted by a central device and that includes an indication to limit access of the devices to the website. The device access limiting system receives an indication of a plurality of user devices to be in communication with a central device during a predetermined time period. For example, the system may receive or identify that students, each having a user device, will be connected to a teacher, having a central device, during a predetermined time period, for example, a scheduled class time.

The system receives an indication for a request to be transmitted to the user devices, where the request identifies a website to be accessed by the user devices. In the indication for the request, the described system provides an option to limit access of the device to only the website included in the request. In other words, the user devices will only be able to access the website indicated in the request and will be unable to access other websites and/or applications on the user device. The request may also include an optional timer feature that allows the teacher to identify a length of time that the access of the devices will be restricted to the identified website. If the request includes a limitation selection, the system will limit the devices to the identified website and, if the timer option was selected, for the desired length of time. Otherwise, the teacher can remove the limiting request as desired. The limiting option does not change any master allow settings, meaning that any filter settings that are set globally are not changed with the limiting indication in the web site request.

Therefore, a system provides a technical improvement over traditional methods for transmitting website requests to user devices connected to a central device. Instead of simply transmitting a website to user devices, the central device can include a limiting feature with the website transmission. By providing the website limiting option, and optional timer, within the website transmission request, the described system significantly reduces the amount of time that the teacher must spend to limit access of the device to only the desired website. Additionally, since the described system provides a device access limiting option that is temporary in nature, meaning it only lasts for as long as the website request is active, the teacher does not have to reconfigure global settings for each desired web site or in order to return the devices to an original state. Thus, the described system and method provides a device limiting technique that is more user friendly, is less cumbersome, requires less time, and provides a more temporary access change as compared to conventional techniques.

The illustrated example embodiments will be best understood by reference to the figures. The following description is intended only by way of example, and simply illustrates certain example embodiments.

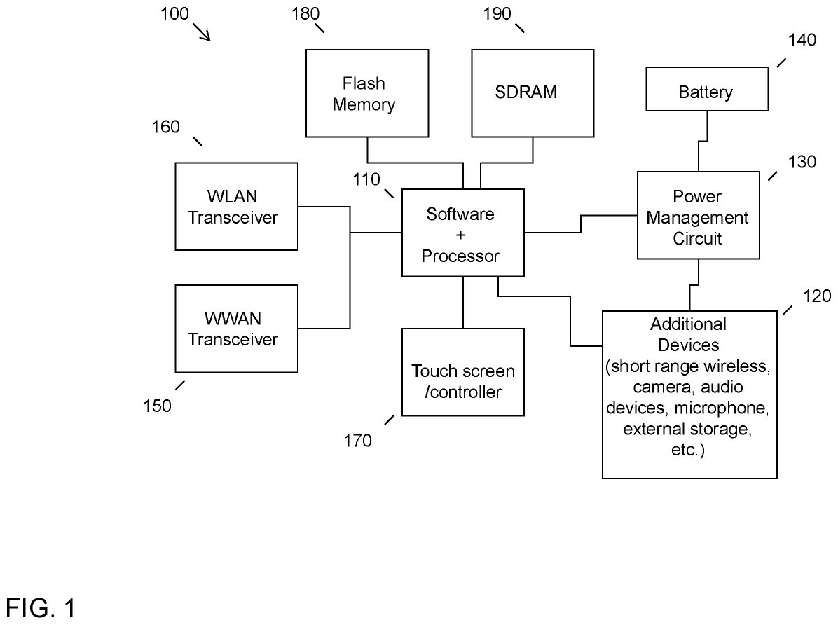

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

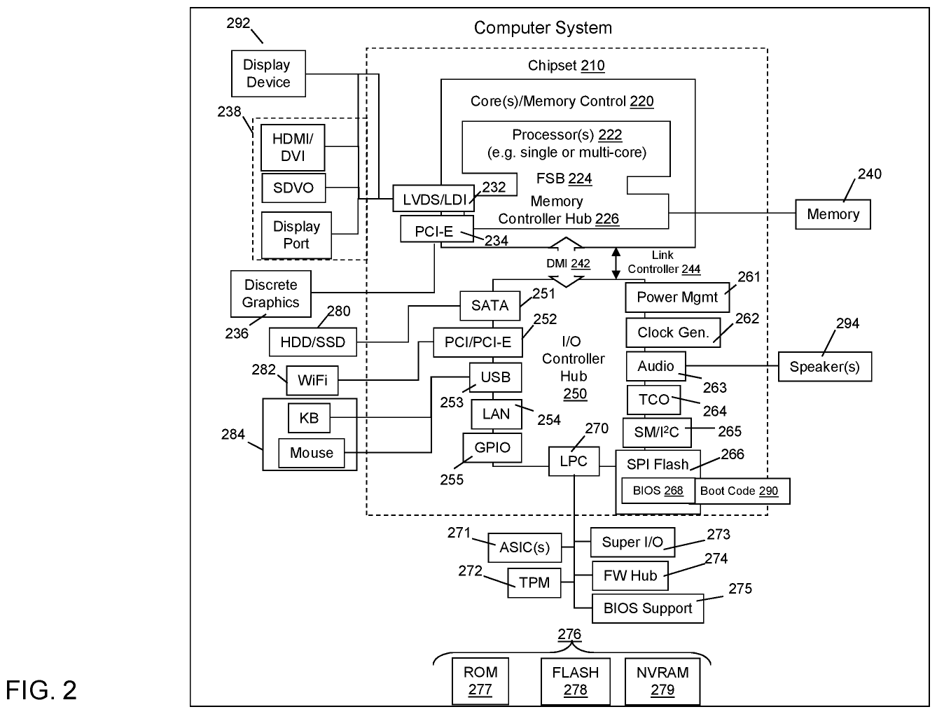

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in systems that limits access of a user device to a web site included in a request from a central device. For example, the circuitry outlined in FIG. 1 may be implemented in a tablet or smart phone embodiment, whereas the circuitry outlined in FIG. 2 may be implemented in a personal computer embodiment.

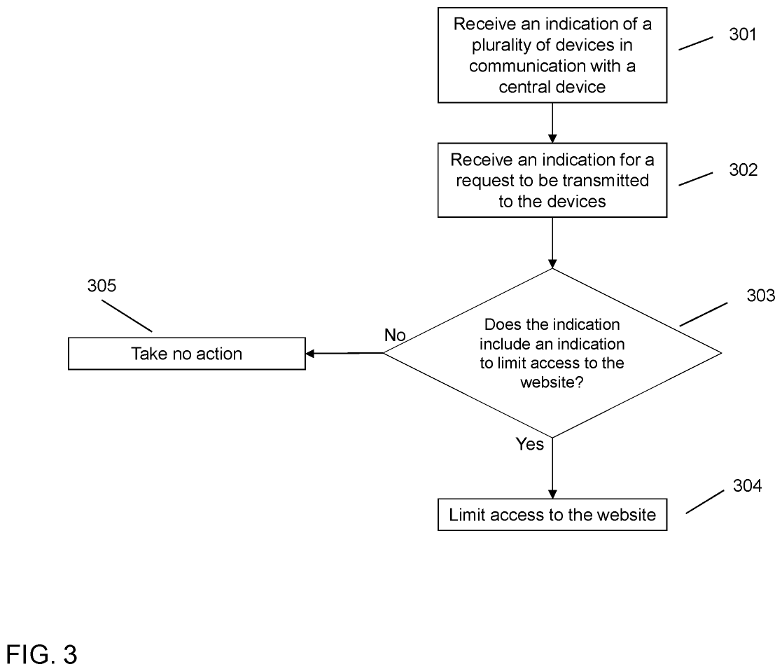

FIG. 3 illustrates an example method for limiting access of user devices to a web site that is included in a request transmitted by a central device and that includes an indication to limit access of the devices to the website. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to limit user devices to accessing a website. Additionally, the device access limiting system includes modules and features that are unique to the described system.

As an example that will be referred to frequently herein, one of the uses or applications of the device access limiting system is a classroom setting having at least two participants located in different physical locations and communicating via one or more communication connections. Generally, the teacher, professor, or other user leading the class, referred to herein as a teacher for ease of readability but not meant to be limiting to such, will have the central device. In conventional classroom management software, this central device is referred to as a console, teacher console, or the like. The user who is a participant and receiving information from the teacher will be referred to as a student, but is not limited to a traditional student definition. Rather, the student may be any person or user who is connected to and receiving information, including communications, web sites, applications, documents, and/or the like, from the central device. The student has a user device that is used to communicate with the central device.

The classroom setting can be completely virtual or remote, meaning the teacher is in one physical location and each of the students is in a different physical location from the teacher and other students. The classroom setting may be completely in-person with all the students and teacher in the same physical location, like a classroom. In this scenario, all of the students and the teacher may each have a device used for communication therebetween. The classroom setting may also be a mixed classroom setting where some students may be in the same physical location as other students or the teacher and other students or the teacher may be located in other physical locations. In each of these settings, each of the students and the teacher may have an individual device. However, it should be noted that students may have the ability to share devices in some situations and the described system can still be utilized. Additionally, some students and/or the teacher may have multiple devices that can be connected together. While the example of a classroom, teacher, and students will be referred to herein, the described system and method is not limited to such an example classroom setting.

At 301, the device access limiting system receives an indication of a plurality of user devices to be in operative communication with a central device during a predetermined time period. At receipt of the indication, the user devices may be in operative communication with the central device. For example, the students may have connected to a classroom which then connects the students to the teacher. The devices may not be in direct communication with each other and, instead, the devices may have some type of software, for example, classroom management software, that facilitates communication between the user devices and the central device. Thus, the communications between the devices may occur through or be otherwise facilitated using the classroom management software. This may be the communication scheme regardless of when the user devices start communication with the central device. In other words, whether the user devices are already in communication with the central device when the indication is received or come into communication with the central device after the indication is received, the general communication scheme is the same.

At receipt of the indication, the user devices may not yet be connected and in communication with the central device. Since the user devices and central device may be connected in a classroom setting, the devices are connected during a predetermined time period, for example, a scheduled meeting time, a scheduled classroom time, and/or the like. It should be noted that while most classes are scheduled well in advanced of the class time, a scheduled time could be scheduled a very short time before the scheduled time, for example, a minute or two before the scheduled time or even a few seconds before the scheduled time. The predetermined time period may also have a specified duration. Thus, the device access limiting system knows when the user devices and central device will be connected and communicating with each other even if they are not yet communicating with each other.

In the case that the devices are already communicating, the indication may be the devices being in communication with each other, the devices accessing the classroom management software or other software that facilitates the classroom setting, and/or the like. In the case that the devices are not already communicating, the indication may be any information that can be used to identify what devices will be or should be communicating with each other and when the communication will occur. Thus, the information may include a classroom schedule, a student class schedule, a teacher class schedule, a meeting or classroom invitation or calendar notification or invitation, class roster, previously enrolled students, and/or the like. The information may also include information contained within the classroom management software, for example, scheduled events, historical schedules, and/or the like.

The device access limiting system may also use historical information to identify schedules and devices that are connected during predetermined time periods. For example, the system may identify that at a particular time each week or each day for a particular duration, certain devices are connected and communicating. This can allow the system to automatically generate a device schedule. Thus, the system may use a learning algorithm to generate a device schedule that allows the system to anticipate connections between devices and times of those connections. A combination of indicators may also be used to identify when and what devices will be or are connected.

At 302, the device access limiting system receives, from the central device, an indication for a request to be transmitted to the plurality of user devices, where the request identifies a website to be accessed during the predetermined time period. In other words, the system receives a push website request to be transmitted to the user devices from the central device. The indication may be the teacher opening the push website request window at the central device. The indication may also be the teacher providing another indication that causes a push web site request to be generated, for example, selecting a website and indicating a push request should be generated from the website, a push website request being automatically generated from information associated with the class, teacher, or the like (class schedule, class agenda, teacher preferences, historical information, etc.), and/or the like. However the indication is initially generated, the push request may be associated with a window, form, and/or other input interface.

It should be noted that while the term website is used here throughout, this term includes any other materials that may be accessed by the user device or pushed from the central device. In practice, the other materials, for example, handouts, coursebooks, notes, applications, and/or the like, would be accessed via a website. Thus, the term “website” encompasses all materials, including website addresses that may be included in a push web site request.

At 303, the device access limiting system determines if the indication includes an indication to limit access to the website. Within the input interface, the device access limiting system provides an option to limit access of the devices to only the website, meaning that, if the limit option is selected, the user devices will be unable to access any other applications, websites, or anything else on the device except for the website included in the request. When the limit option is selected, it causes the user devices to be limited to only accessing the website. However, the limit option does not cause the master filter settings to be changed. In other words, the limit option overrides the master filter settings, but does not materially change the master filter settings. The limit option may be selected in the form of a radial button, checkbox, or other selection mechanism in the input interface.

Accordingly, the device access limiting system may identify the master filter settings that are initiated or stored on the central device. The master filter settings identify websites and applications that can be accessed by the user devices during the predetermined time period. In other words, the master filter settings identify websites and applications that the user device is allowed to access during the predetermined time period. When the limit option is selected, these master filter settings are overridden to only allow the devices to access the website included within the website request and while the request is active. However, the master filter settings are not modified or otherwise changed by the system through the use of the limit option. In other words, the master filter settings are deactivated, but remain unchanged, while the limit request is active. Thus, the limit request has a higher priority than the master filter settings.

When overriding the master filter settings, the device access limiting system may temporarily add the website included within the request to an access allowed list. This may occur when the website is not already included in an access allowed list, meaning the website has not been previously identified and included on the master filter settings list or another allow list. On the other hand, if the web site included within the request is already included on an access allowed list, overriding the master filter settings may include temporarily reducing the websites and applications that are on the access allowed list to only the website included in the request.

The input interface may also include a timer option. The timer option may be provided as a checkbox, radial button, or other selection input mechanism. The timer option also includes an input box that allows the teacher to select a length of time that the request and limit option should be active for. The input box may be a freeform input box that is restricted to numbers, an input box with selection arrows, a clock interface, and/or the like. In some embodiments, the timer option may only be the length of time input and may not include the selection input mechanism. In this case, the timer option will be assumed to be unselected if the length of time input is left blank or remains unchanged from a default value.

If the timer option is selected, the teacher indicates a time period that the device will be limited. In other words, the timer option will allow the teacher to set a time for the website request and limit option to be active. The input interface can include a timer option that can be an optional input by the teacher. In other words, the input interface will include the timer option but it is not required to be selected or filled in by the teacher, even if the limit option is selected. In the case that the teacher does not provide input into the timer option, the request and limiting will be active until the teacher indicates it should not be active anymore. In other words, the teacher can release the access limiting.

Thus, to determine if the indication includes an indication to limit access of the user devices to only the website included in the request at 303, the system may determine if the limit option is selected in the input interface. If the limit option is selected, the system determines that the indication includes an indication to limit access of the plurality of user devices to the website. If the limit option is not selected, the system determines that the indication does not include an indication to limit access of the plurality of user devices to the website.

If the device access limiting system determines that the indication does not include an indication to limit access of the user devices at 303, the system may take no action at 305. This means that the push request will work as in conventional systems where the students can access other websites, applications, or materials, even when the request is active.

On the other hand, if the device access limiting system determines that the indication does include an indication to limit access of the user devices at 303, the system may limit access of the device to the website at 304. In other words, the device access limiting system limits access of the devices to only the web site and does not allow the user devices to access any other websites, applications, or materials while the request is active. Limiting access of the user devices to the website included in the request includes prevent access to websites, applications, and/or materials other than the website included in the request. The access limiting can be facilitated using allow lists, setting changes, and/or the like, as previously discussed herein.

As previously mentioned, the request may include a timer that, upon expiration of the time, causes the request to be removed and restores access of the user devices to other allowed websites, applications, and/or materials. On the other hand, if the request does not include a timer, the request and limit option stay active until the teacher un-limits or removes the request or limit option. Thus, the teacher may provide an indication via the central device to un-limit access of the user devices to applications other than the website and removing the limiting of access.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a device access limiting system, an indication of a plurality of user devices to be in operative communication with a central device during a predetermined time period;
receiving, at the device access limiting system from the central device, an indication for a request to be transmitted to the plurality of user devices to access a website during the predetermined time period;
determining, using the device access limiting system, the indication comprises an indication to limit access of the plurality of user devices to the website; and
limiting, using the device access limiting system, access of the plurality of user devices to the website.

2. The method of claim 1, wherein the request comprises an indication of a length of time associated with the request and wherein the limiting comprises limiting the access for the length of time.

3. The method of claim 1, comprising receiving an indication from the central device to un-limit access of the plurality of user devices to applications other than the website and removing the limiting of access.

4. The method of claim 1, wherein the limiting access comprises preventing access to web sites other than the website.

5. The method of claim 1, wherein the limiting access comprises preventing access to applications other than the website.

6. The method of claim 1, comprising identifying master filter settings initiated by the central device to the plurality of user devices, wherein the master filter settings identify websites and applications the plurality of user devices are allowed to access during the predetermined time period.

7. The method of claim 6, wherein the limiting comprises overriding the master filter settings while the request is active at the plurality of user devices without modifying the master filter settings.

8. The method of claim 7, wherein the overriding the master filter settings comprises temporarily adding the website to an access allowed list.

9. The method of claim 7, wherein the overriding the master filter settings comprises temporarily reducing the websites and applications that are allowed to only the web site.

10. The method of claim 1, wherein the indication for the request and the indication to limit access are providing in a single user input area.

11. An information handling device, the information handling device comprising:
a central device;
a plurality of user devices;
a processor operatively coupled to the central device and the plurality of user devices;
a memory device that stores instructions that, when executed by the processor, causes the information handling device to:
receive, at a device access limiting system, an indication of the plurality of user devices to be in operative communication with the central device during a predetermined time period;
receive, at the device access limiting system from the central device, an indication for a request to be transmitted to the plurality of user devices to access a website during the predetermined time period;
determine, using the device access limiting system, the indication comprises an indication to limit access of the plurality of user devices to the website; and
limit, using the device access limiting system, access of the plurality of user devices to the website.

12. The information handling device of claim 11, wherein the request comprises an indication of a length of time associated with the request and wherein the limiting comprises limiting the access for the length of time.

13. The information handling device of claim 11, comprising receiving an indication from the central device to un-limit access of the plurality of user devices to applications other than the website and removing the limiting of access.

14. The information handling device of claim 11, wherein the limiting access comprises preventing access to websites other than the website.

15. The information handling device of claim 11, wherein the limiting access comprises preventing access to applications other than the web site.

16. The information handling device of claim 11, comprising identifying master filter settings initiated by the central device to the plurality of user devices, wherein the master filter settings identify websites and applications the plurality of user devices are allowed to access during the predetermined time period.

17. The information handling device of claim 16, wherein the limiting comprises overriding the master filter settings while the request is active at the plurality of user devices without modifying the master filter settings.

18. The information handling device of claim 17, wherein the overriding the master filter settings comprises temporarily adding the website to an access allowed list.

19. The information handling device of claim 17, wherein the overriding the master filter settings comprises temporarily reducing the websites and applications that are allowed to only the website.

20. A product, the product comprising:
a computer-readable storage device that stores executable code that, when executed by a processor, causes the product to:
receive, at a device access limiting system, an indication of a plurality of user devices to be in operative communication with a central device during a predetermined time period;
receive, at the device access limiting system from the central device, an indication for a request to be transmitted to the plurality of user devices to access a website during the predetermined time period;
determine, using the device access limiting system, the indication comprises an indication to limit access of the plurality of user devices to the website; and
limit, using the device access limiting system, access of the plurality of user devices to the website.
